(19) United States
(12) Patent Application Publication
(10) Pub. No.: US 2026/0095689 A1
(43) Pub. Date: Apr. 2, 2026

(54) RADIO FREQUENCY ANTENNA ARCHITECTURE FOR A WIRELESS EARBUDS CASE

(71) Applicant: Motorola Mobility LLC, Chicago, IL (US)

(72) Inventors: Xuyuan Pan, Chicago, IL (US); Andrius Vytenis Lietuvninkas, Lemont, IL (US); Junsheng Zhao, Vernon Hills, IL (US); Md Faisal Abedin, Lisle, IL (US)

(73) Assignee: Motorola Mobility LLC, Chicago, IL (US)

(21) Appl. No.: 18/902,304

(22) Filed: Sep. 30, 2024

(51) Int. Cl. H04R 1/10; H01Q 1/22

(52) U.S. Cl. CPC H04R 1/1041; H01Q 1/22; H04R 1/1016; H04R 1/1025; H04R 2420/07

(57) ABSTRACT

In accordance with the described techniques, a device is configured as an earbuds case that includes cavities configured for housing a pair of wireless earbuds and at least one radio frequency antenna positioned at least partially beneath the cavities. An activation of the at least one radio frequency antenna is controlled based on whether the wireless earbuds are inserted in the cavities.

### BACKGROUND

True wireless earbuds are a type of earbuds that operate without any physical connection between the left and right earbuds or to an audio source. In particular, true wireless earbuds utilize wireless connectivity (e.g., a Bluetooth connection) for wireless communication, allowing users to enjoy music, calls, and other audio without the hassle of wires. True wireless earbuds have gained popularity due to their convenience and portability. As true wireless earbud technology advances, the features of true wireless earbuds also advance, including improved noise cancellation, implementation of touch controls, voice assistant integration, and enhanced battery life. A pair of true wireless earbuds typically comes with an earbuds case that houses and charges the pair of true wireless earbuds to extend earbud battery life.

### BRIEF DESCRIPTION OF THE DRAWINGS

Aspects of radio frequency antenna architecture for a wireless earbuds case are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of radio frequency antenna architecture for a wireless earbuds case can be implemented;

FIG. 2 illustrates an example of an antenna architecture for radio frequency antenna architecture for a wireless earbuds case;

FIG. 3 illustrates an example system for activating and deactivating one or more radio frequency antennas in accordance with the described techniques;

FIG. 4 illustrates a flow chart depicting an example method for radio frequency antenna architecture for a wireless earbuds case as implemented at least partially by an antenna switching module configured as an electrical switch;

FIG. 5 illustrates a flow chart depicting an example method for radio frequency antenna architecture for a wireless earbuds case as implemented at least partially by an antenna switching module configured as a mechanical switch;

FIG. 6 illustrates various components of an example device in which aspects of the described techniques can be implemented.

### DETAILED DESCRIPTION

Radio frequency antenna architecture for a wireless earbuds case is discussed herein. Generally, the techniques discussed herein are directed to an earbuds case configured for housing a pair of wireless earbuds. Unlike conventional cases for true wireless earbuds, the earbuds case is configured for wireless communication with one or more networks, e.g., cellular networks and Wi-Fi networks. For example, the earbuds case includes a communication system having a subscriber identity module (SIM) chip, a modem (e.g., a modulator-demodulator), a radio frequency (RF) front end, an antenna system having a plurality of antennas (e.g., RF antennas such as Wi-Fi antennas and cellular antennas), and/or additional circuitry facilitating wireless network connectivity.

Notably, earbuds cases are considered space-constrained devices because a key feature of wireless earbuds and earbuds cases is portability, which necessitates small form factor designs, e.g., in order for the wireless earbuds case to easily fit into a user's pocket. Moreover, the integration of the communication system into the earbuds case further exacerbates the space limitations for the earbuds case, e.g., because the components of the earbuds case are more densely arranged than conventional earbuds cases in order to fit the additional components of the communication system while maintaining a small form factor. The small form factor and space limitations of the earbuds case can lead to placement of antennas of the antenna system in relatively close proximity, which can result in unintentional antenna coupling, e.g., interference. The wireless earbuds additionally include antennas (e.g., Bluetooth antennas) that can interfere with the antennas of the antenna system. This antenna interference can degrade wireless communication performance of the earbuds case. Accordingly, techniques are discussed herein to reduce antenna interference while improving wireless communication performance of the earbuds case.

In various implementations, the described techniques are directed to an antenna arrangement within the earbuds case that increases spacing between the antennas. For example, the earbuds case includes a first housing configured as a base and a second housing configured as a tray. The base and the tray are physically attached to one another in order to enclose one or more circuitry components of the earbuds case, e.g., the communication system. Furthermore, the tray includes cavities configured for housing the pair of wireless earbuds. Here, the antennas of the antenna system include one or more cellular antennas, one or more Wi-Fi antennas, one or more UWB antennas, and one or more Bluetooth antennas each positioned within the base and along a perimeter region of the base. In addition, the antenna system includes one or more tray RF antennas (e.g., Wi-Fi antennas and/or cellular antennas) that are positioned within the tray of the earbuds case. To increase spacing between the tray RF antenna(s) and the additional antennas positioned within the base, the tray RF antenna(s) are generally centrally positioned within the tray and base assembly. In various examples, a tray RF antenna is comprised of two arms, with a first arm positioned beneath a first cavity within the tray and conforming to a shape of the first cavity, and a second arm positioned beneath a second cavity within the tray and conforming to a shape of the second cavity.

In addition, the earbuds case includes a controller which detects a positional status of the wireless earbuds indicating whether the wireless earbuds are inserted in the cavities. Based on the positional status, the controller controls an activation of the one or more tray RF antennas. For example, the controller initiates an activation of the one or more tray RF antennas responsive to detecting that the wireless earbuds are inserted in the cavities of the earbuds case. Moreover, the controller initiates a deactivation of the one or more tray RF antenna responsive to detecting that the wireless earbuds have been removed from the cavities of the earbuds case. The antennas positioned in the base, however, remain activated regardless of whether the wireless earbuds are inserted in the cavities of the earbuds case. Given this, one or more tray RF antennas and one or more RF antennas positioned in the base are activated and operable as a multiple input, multiple output (MIMO) antenna system while the wireless earbuds are removed from the cavities. Generally, MIMO antenna systems use multiple antennas at both the transmitter and the receiver ends, thereby enabling multiple data streams to be transmitted and received simultaneously which improves wireless communication performance and coverage relative to single input, single output (SISO) antennas.

By dispersing the antennas of the antenna system in the manner described, the described techniques increase spacing between the antennas, which reduces unintentional antenna coupling and interference. Moreover, the described techniques deactivate the tray RF antenna(s) when the wireless earbuds are inserted in the earbuds case to further reduce antenna coupling and interference when the wireless earbuds are not actively being used by the user. Furthermore, the described techniques improve wireless communication performance of the wireless earbuds when the earbuds are actively being used by the user by enabling MIMO operation of the tray RF antenna(s) and at least one additional RF antenna of the antenna system.

While features and concepts of radio frequency antenna architecture for a wireless earbuds case can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

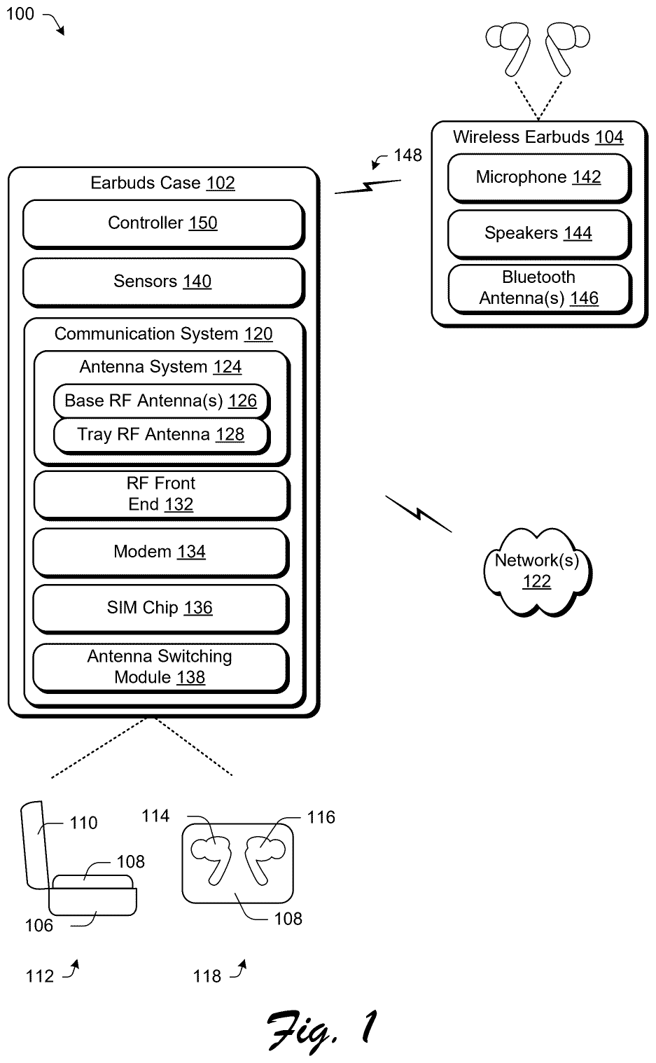

FIG. 1 illustrates an example environment 100 in which aspects of radio frequency antenna architecture for a wireless earbuds case can be implemented. The environment 100 includes an earbuds case 102 and a pair of wireless earbuds 104, e.g., true wireless earbuds. As shown, the earbuds case 102 includes a first housing configured as a base 106 of the earbuds case 102, a second housing configured as a tray 108 of the earbuds case 102, and a third housing configured as a lid 110 of the earbuds case. In one or more implementations, the base 106 and the tray 108 are physically coupled and/or attached to one another, forming an assembly of the base 106 and the tray 108. The assembly, for instance, is a housing that includes two sub-housings (e.g., the base 106 and the tray 108), and the assembly encloses one or more circuitry components of the earbuds case 102.

Although not illustrated, the earbuds case 102 includes a hinge coupling the assembly (e.g., including the base 106 and the tray 108) to the lid 110. The hinge enables the assembly and the lid 110 to pivot or rotate about the hinge relative to one another between an open position and a closed position. A side view of a non-limiting example earbuds case in the open position is illustrated at 112. Generally, the earbuds case 102 is configured to house the wireless earbuds 104. For example, the tray 108 and/or the lid 110 include two cavities (e.g., a first cavity 114 and a second cavity 116) conforming to a shape of the wireless earbuds 104. A top view of a non-limiting example tray 108 including the cavities 114, 116 is illustrated at 118. The wireless earbuds 104 are insertable into the cavities 114, 116 when the earbuds case 102 is in the open position. Moreover, the earbuds case 102 (e.g., the lid 110) is configured to enclose the wireless earbuds 104 when the wireless earbuds 104 are inserted in the earbuds case 102 that is arranged in the closed position. Although not shown, the earbuds case 102 includes a battery and a charging circuit which electrically connects to the wireless earbuds 104 when they are inserted in the earbuds case 102 to enable the battery to charge the wireless earbuds 104.

As shown, the earbuds case 102 includes a communication system 120 which is generally configured to enable wireless connectivity with one or more networks 122 (e.g., cellular networks and Wi-Fi networks) and other devices, e.g., the wireless earbuds 104. To enable network and inter-device connectivity, the communication system 120 includes an antenna system 124, which includes any one or more of various types of antennas. Example antennas of the antenna system 124 include, but are not limited to including, ultra-wideband (UWB) antennas, Wi-Fi antennas (e.g., radio frequency (RF) antennas operating in frequency bands used by Wi-Fi networks), Bluetooth antennas, cellular antennas (e.g., RF antennas operating in frequency bands used by cellular networks, such as 3G, 4G LTE, and 5G cellular networks), global positioning system (GPS) antennas, and near field communication (NFC) antennas.

In particular, the antenna system 124 includes one or more base RF antennas 126, which are RF antennas positioned within the base 106 of the earbuds case 102. In one example, the base RF antennas 126 include one or more Wi-Fi antennas, e.g., antennas designed to operate in frequency bands used by Wi-Fi networks such as the 2.4 GHz or 5 GHz band. Additionally or alternatively, the base RF antennas 126 include one or more cellular RF antennas designed to operate in any one or any combination of the “low” RF band, the “mid” RF band, the “high” RF band, and the “ultra-high” RF band. Broadly, the low RF band refers to an RF spectrum including frequencies that are less than the mid RF band (e.g., less than 1 GHz), the mid RF band refers to an RF spectrum including frequencies that are higher than the low RF band but less than the high RF band (e.g., 1 GHz to 6 GHz), the high RF band refers to an RF spectrum including frequencies that are higher than the mid RF band but less than the ultra-high RF band (e.g., 6 GHz to 30 GHz), and the ultra-high RF band refers to an RF spectrum including frequencies that are higher than the high RF band, e.g., above 30 GHz.

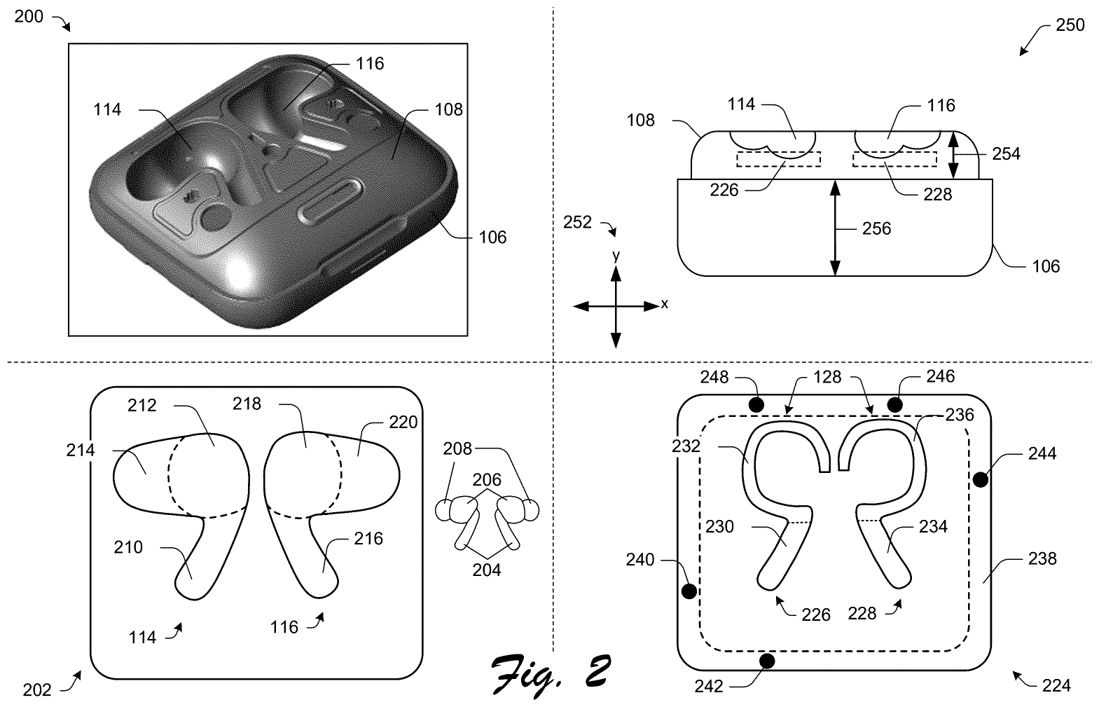

Furthermore, the antenna system 124 includes one or more tray RF antennas 128, which are RF antennas positioned within the tray 108 of the earbuds case 102. In one or more implementations, the tray RF antennas 128 include Wi-Fi antennas. Additionally or alternatively, the tray RF antennas 128 include one or more cellular antennas operating in any one or any combination of the low band, the mid band, the high band, and the ultra-high band. An example of the configuration, design, and placement of the antenna system 124 within the earbuds case 102 is provided below with reference to FIG. 2.

Accordingly, one or more base RF antennas 126 and one or more tray RF antennas 128 that are activated and operating in a same frequency band are combinable to operate as a multiple input, multiple output (MIMO) antenna system. Generally, MIMO antenna systems use multiple antennas at both the transmitter and the receiver ends, thereby enabling multiple data streams to be transmitted and received simultaneously. As compared to single input single output (SISO) antenna systems, MIMO antenna systems improve wireless communication performance and coverage by increasing data throughput, improving spectral efficiency, and providing spatial antenna diversity. Similarly, MIMO systems having an increased number of antennas (e.g., a 4×4 MIMO system) exhibit better performance characteristics (e.g., increased data throughput) than MIMO systems having a decreased number of antennas, e.g., a 2×2 MIMO system.

By way of example, one or more base RF antennas 126 configured as low band antennas (e.g., operating in the low RF band) and one or more tray RF antennas 128 configured as low band antennas are combinable to operate as a low band MIMO antenna system. In another example, one or more base RF antennas 126 configured as Wi-Fi antennas and one or more tray RF antennas 128 configured as Wi-Fi antennas are combinable to operate as a Wi-Fi MIMO antenna system. In yet another example, one or more base RF antennas 126 configured as mid to ultra-high band (MB/HB/UHB) antennas (e.g., operating in the mid RF band, the high RF band, and the ultra-high RF band) and one or more tray RF antennas 128 configured as MB/HB/UHB antennas are combinable to operate as a MB/HB/UHB MIMO antenna system. In various non-limiting examples, one base RF antenna 126 and one tray RF antenna 128 are combinable to form a two RF antenna MIMO system (e.g., a 2×2 MIMO antenna system) or two base RF antennas 126 and two tray RF antennas 128 are combinable to form a four RF antenna MIMO system, e.g., a 4×4 MIMO system. However, it is to be appreciated that a MIMO system including base RF antenna(s) 126 and tray RF antenna(s) 128, as described herein, is not limited by the type of RF antenna or the number of RF antennas included therein. Rather, a MIMO system as described herein includes at least one base RF antenna 126 and at least one tray RF antenna 128, and the antennas 126, 128 can be any type of RF antenna that operate in a same RF frequency band.

The communication system 120 is further illustrated as including a radio frequency (RF) front end 132, which is implemented in electronic circuitry to process RF signals. More specifically, the RF front end 132 processes RF signals received by one or more antennas (e.g., Wi-Fi antenna(s) or cellular antenna(s)) of the antenna system 124, filters out unwanted frequencies, amplifies desired frequencies (e.g., using a low-noise amplifier), and down-converts the received RF signals to baseband signals in a baseband frequency. In addition, the RF front end 132 processes baseband signals, up-converts them to the desired RF frequency, amplifies the signals (e.g., using a power amplifier), filters out unwanted frequencies, and then transmits the signal using the one or more antennas, e.g., Wi-Fi antenna(s) or cellular antenna(s). Notably, baseband signals are unmodulated signals containing the actual data (e.g., audio, text, and/or digital data) being transmitted or received.

Moreover, the communication system 120 includes a modem 134 (e.g., a modulator-demodulator), which is implemented in electronic circuitry to modulate digital signals and demodulate analog signals. More specifically, the modem 134 converts (e.g., modulates) digital data to be transmitted over the network(s) 122 to RF signals that are communicable over the wireless network(s) 122, e.g., Wi-Fi networks and cellular networks. Furthermore, the modem 134 converts (e.g., demodulates) RF signals received from wireless network(s) 122 (e.g., Wi-Fi networks and cellular networks) to digital data processable by digital circuitry of the earbuds case 102.

The communication system 120 is illustrated as including a subscriber identity module (SIM) chip 136. In variations, the SIM chip 136 is a removable SIM chip (e.g., capable of being physically inserted and removed from the earbuds case 102) or an embedded SIM (eSIM) chips, e.g., embedded in hardware of the earbuds case. Generally, the SIM chip 136 is configured to store one or more SIM profiles, which enable provision of services from a cellular network operator to the earbuds case 102. For example, a SIM profile includes an international mobile subscriber identity (IMSI) number which uniquely identifies a subscriber to the cellular network operator, security keys, and service plan information, e.g., a phone number associated with the user/subscriber. When a device (e.g., the earbuds case 102) connects to the cellular network, the cellular network authenticates the user as a subscriber using the IMSI and the security keys in the SIM profile. This enables the device (e.g., the earbuds case 102) to access the cellular network, including the ability to make calls and send/receive short message service (SMS) text messages using the phone number in the SIM profile.

The communication system 120 also includes an antenna switching module 138, which is generally configured to dynamically deactivate and activate antennas of the antenna system 124. By way of example, the antenna switching module 138 dynamically switches between different combinations of active antennas in the antenna system 124 that are actively receiving and transmitting signals. As further discussed below, for instance, the antenna switching module 138 is configured to activate the tray RF antenna(s) 128 responsive to the wireless earbuds 104 being removed from the cavities 114, 116, and deactivate the tray RF antenna(s) 128 responsive to the wireless earbuds 104 being inserted in the cavities 114, 116.

As shown, the earbuds case 102 additionally includes sensors 140, examples of which include motion sensors (e.g., a gyrometer and an accelerometer) and touch sensors. In accordance with the described techniques, the sensors 140 include an insertion sensor, which is configured to detect whether the earbuds 104 are inserted in the earbuds case 102. Examples of the insertion sensor include Hall Effect Sensors, capacitive proximity sensors, optical sensors, and mechanical switches.

The wireless earbuds 104 include at least one microphone 142 that enables input of audio (e.g., voice) data via the wireless earbuds 104. In addition, the wireless earbuds 104 include one or more speakers 144 (e.g., at least one speaker per earbud 104) enabling output of audio data via the wireless earbuds 104. Moreover, the wireless earbuds 104 are illustrated as including one or more Bluetooth antennas 146, which enable short-range wireless communication of data between the earbuds case 102 and the wireless earbuds 104. For example, the earbuds case 102 and the wireless earbuds 104 are communicatively coupled via a peer-to-peer connection 148. By way of example, the Bluetooth antenna(s) of the antenna system 124 and the Bluetooth antenna(s) 146 of the wireless earbuds 104 facilitate short-range wireless communication of data between the earbuds case 102 and the wireless earbuds 104 via a Bluetooth connection or Bluetooth Low Energy (BLE) connection.

As discussed, the earbuds case 102 is equipped with wireless communication capabilities to transmit and receive data over the network(s) 122 (e.g., cellular networks and/or Wi-Fi networks), while the wireless earbuds 104 are not equipped with such wireless network communication capabilities. Thus, in order to receive wireless cellular or Wi-Fi communications, the wireless earbuds 104 receive the communications via the peer-to-peer connection 148 with the earbuds case 102 in one or more implementations. When the wireless earbuds 104 are connected to the earbuds case 102, for instance, the earbuds case 102 receives a wireless cellular or Wi-Fi communication and communicates data (e.g., audio data) of the communication via the peer-to-peer connection 148 for output by the speakers 144.

Notably, earbuds cases are space-constrained devices because a key feature of wireless earbuds and earbuds cases is portability, which necessitates small form factor designs, e.g., in order for the wireless earbuds case to easily fit into a user's pocket. Moreover, conventional earbuds cases are not equipped with wireless network communication capabilities. For example, conventional earbuds cases do not include RF antennas (e.g., cellular and Wi-Fi antennas), an RF front end 132, a modem 134, a SIM chip 136, and/or an antenna switching module 138. Thus, the integration of the communication system 120 into the earbuds case 102 further exacerbates the space limitations for the earbuds case 102, e.g., because the components of the earbuds case 102 are more densely arranged than conventional earbuds cases in order to fit the additional components of the communication system 120 while maintaining a small form factor. The small form factor and space limitations of the earbuds case 102 can lead to placement of antennas of the antenna system 124 in relatively close proximity, which can result in unintentional antenna coupling, e.g., interference. Moreover, the wireless earbuds 104 additionally include antennas (e.g., the Bluetooth antennas 146) that can interfere with the antennas of the antenna system 124. This antenna interference can degrade wireless communication performance of the earbuds case 102.

In accordance with the described techniques, the antennas of the antenna system 124 are arranged in the earbuds case 102 in a manner that increases spacing between the different antennas, as further discussed below with reference to FIG. 2. As part of this spacing paradigm, the tray RF antenna(s) 128 are positioned beneath the cavities 114, 116 within the tray 108 in one or more examples. In other words, the tray RF antenna(s) 128 are positioned proximately beneath the wireless earbuds 104 when the wireless earbuds 104 are inserted in the cavities 114, 116, which can lead to interference between the tray RF antenna(s) 128 and antennas of the wireless earbuds 104, e.g., the Bluetooth antenna(s) 146. Thus, a controller 150 (e.g., implemented in digital circuitry) of the earbuds case 102 is configured to detect (e.g., based on sensor data received from the insertion sensor of the sensors 140) whether the wireless earbuds 104 are inserted in the cavities 114, 116. Responsive to detecting the wireless earbuds 104 being inserted in the cavities 114, 116, the controller 150 initiates a deactivation of the tray RF antenna(s) 128, e.g., by instructing the antenna switching module 138 to deactivate the tray RF antenna(s) 128. In response to detecting the wireless earbuds 104 being removed from the cavities 114, 116, the controller 150 initiates an activation of the tray RF antenna(s) 128, e.g., by instructing the antenna switching module 138 to activate the tray RF antenna(s) 128. In various implementations, the base RF antenna(s) 126 remain activated regardless of whether the wireless earbuds 104 are inserted in the cavities 114, 116

Accordingly, the techniques discussed herein enable operation of one or more tray RF antennas 128 and one or more base RF antennas 126 as a MIMO antenna system when the wireless earbuds 104 are removed from the earbuds case 102 and actively being used by a user. Moreover, the described techniques deactivate the tray RF antenna 128 when the wireless earbuds 104 are inserted in the earbuds case 102 to reduce antenna coupling and interference when the wireless earbuds 104 are not actively being used by the user. In addition, and as further discussed below with reference to FIG. 2, the antennas are dispersed throughout the earbuds case 102 in a manner that increases antenna spacing. For at least these reasons, the described techniques improve wireless communication performance of the earbuds case 102.

Having discussed an example environment in which the disclosed techniques can be performed, consider now some example scenarios and implementation details for implementing the disclosed techniques.

FIG. 2 illustrates an example of an antenna architecture for radio frequency antenna architecture for a wireless earbuds case. The illustrated example includes a three-dimensional view 200 of the assembly of the earbuds case 102. As previously mentioned, for instance, the earbuds case 102 includes a first housing configured as the base 106 and a second housing configured as the tray 108. As shown, the base 106 and the tray 108 are physically attached to one another (e.g., via plastic welding, adhesive bonding, screws and mechanical fasteners, or any other attachment mechanism) to form an assembly. Furthermore, the tray 108 includes a first cavity 114 that conforms to a shape of first wireless earbud 104 of the pair of wireless earbuds 104, such that the first cavity 114 is configured for housing the first wireless earbud 104. Moreover, the tray 108 includes a second cavity 116 that conforms to a shape of the second wireless earbud 104 of the pair of wireless earbuds 104, such that the second cavity 116 is configured for housing the second wireless earbud 104. Indeed, the first wireless earbud 104 is insertable in the first cavity 114 and the second wireless earbud 104 is insertable in the second cavity 116 when the lid 110 (not shown) is arranged in the open position. In this way, the earbuds case 102 encloses the wireless earbuds 104 when the lid 110 is arranged in the closed position.

The illustrated example further includes a top view 202 of the tray 108. As shown, the top view 202 includes the first cavity 114 and the second cavity 116. Generally, the cavities 114, 116 include sub-cavities (e.g., separated by the dashed lines in the top view 202) configured for housing differently shaped physical components of the wireless earbuds 104. For example, each of the wireless earbuds 104 include a stem 204, a body 206, and a tip 208. To house the first wireless earbud 104, the first cavity 114 includes a stem sub-cavity 210 configured for housing the stem 204 of the first wireless earbud 104 that conforms to a shape of the stem 204, a body sub-cavity 212 configured for housing the body 206 of the first wireless earbud 104 that conforms to a shape of the body 206, and a tip sub-cavity 214 configured for housing the tip 208 of the first wireless earbud 104 that conforms to a shape of the tip 208. To house the second wireless earbud 104, the second cavity 116 includes a stem sub-cavity 216 configured for housing the stem 204 of the second wireless earbud 104 that conforms to a shape of the stem 204, a body sub-cavity 218 configured for housing the body 206 of the second wireless earbud 104 that conforms to a shape of the body 206, and a tip sub-cavity 220 configured for housing the tip 208 of the second wireless earbud 104 that conforms to a shape of the tip 208.

In addition, a top view 224 of the assembly of the earbuds case 102 having the tray 108 removed is shown in the illustrated example. In particular, the top view 224 includes a tray RF antenna 128 which includes a first arm 226 and a second arm 228. As shown, the first arm 226 is positioned at least partially beneath the first cavity 114, while the second arm 228 is positioned at least partially beneath the second cavity 116. By way of example, the first arm 226 includes a first portion 230 that is positioned directly beneath the stem sub-cavity 210 of the first cavity 114 and extends in parallel with the stem sub-cavity 210. In addition, the first arm 226 includes a second portion 232 that is positioned beneath the body sub-cavity 212 of the first cavity 114 and wraps at least partially around the body sub-cavity 212. Similarly, the second arm 228 includes a first portion 234 that is positioned directly beneath the stem sub-cavity 216 of the second cavity 116 and extends in parallel with the stem sub-cavity 216. In addition, the second arm 228 includes a second portion 236 that is positioned beneath the body sub-cavity 218 of the second cavity 116 and wraps at least partially around the body sub-cavity 218 when the tray 108 is attached.

Furthermore, the top view 224 shows a perimeter region 238 of the base 106 of the earbuds case 102, which is generally disposed along a perimeter or edge of the base 106 of the earbuds case 102. In order to increase spacing between the tray RF antenna 128 and additional antennas of the antenna system 124, the additional antennas (e.g., including the base RF antennas 126) are positioned within the perimeter region 238 of the base 106. The top view 224 illustrates a non-limiting example dispersion of the additional antennas of the antenna system 124. The non-limiting example dispersion illustrates a placement of a MB/HB/UHB antenna (at 240), a placement of a Bluetooth antenna (at 242), a placement of a low band antenna (at 244), a placement of a Wi-Fi antenna (at 246), and a placement of a UWB antenna (at 248).

The illustrated example further includes a side view 250 of the assembly including the base 106 and the tray 108. Here, the side view 250 includes the cavities 114, 116, and the arms 226, 228 of the tray RF antenna 128 (as illustrated by the dashed lines). Moreover, the side view 250 includes a cartesian plane 252 illustrating an x-direction and a y-direction. As discussed herein, a first component of the earbuds case 102 is considered to be positioned “beneath” a second component of the earbuds case 102 if the first component is positioned in the downward y-direction of the cartesian plane 252 relative to the second component. As shown, for instance, the first arm 226 is positioned beneath the first cavity 114, and the second arm 228 is positioned beneath the second cavity 116.

Notably, the union of the illustrated dashed lines of the first arm 226 with the illustrated solid lines of the first cavity 114 illustrates that the second portion 232 of the first arm 226 wraps at least partially around the body sub-cavity 212 of the first cavity 114. Similarly, the union of the illustrated dashed lines of the second arm 228 with the illustrated solid lines of the second cavity 116 illustrates that the second portion 236 of the second arm 228 wraps at least partially around the body sub-cavity 218 of the first cavity 114.

Furthermore, the tray 108 is illustrated as occupying a space 254, while the base 106 is illustrated as occupying a space 254. In one or more implementations, a component is considered to be positioned “within” the tray 108 if the component is positioned entirely within the space 254. Similarly, a component is considered to be positioned “within” the base 106 if the component is positioned entirely within the space 256. Here, the arms 226, 228 of the tray RF antenna 128 are positioned within the tray 108, as shown. Moreover, the additional antennas of the antenna system 124 including the base RF antenna(s) 126 are positioned within the base 106.

It should be noted that the described techniques are not limited by the example antenna arrangement and shape of the tray RF antenna 128 as depicted in FIG. 2. Indeed, in one or more alternative implementations, the arms 226, 228 of the tray RF antenna 128 are integrated within the housing of the tray 108 rather than being positioned beneath the tray 108 and enclosed by the assembly of the base 106 and the tray 108. Additionally or alternatively, the tray RF antenna 128 can include a spring which causes the tray RF antenna 128 to spring up responsive to the wireless earbuds 104 being removed from the cavities 114, 116 in order to occupy a space within the cavities 114, 116. In addition or as an alternative, the tray RF antenna 128 is a different shape, and/or the tray 108 includes additional tray RF antennas 128 within the tray 108. Moreover, the base 106 includes different antennas or different combinations of the aforementioned antennas that are optionally dispersed differently than the aforementioned non-limiting example antenna dispersion. Accordingly, the antenna system 120 is configurable and arrangeable in various manners without departing from the spirit or scope of the described techniques.

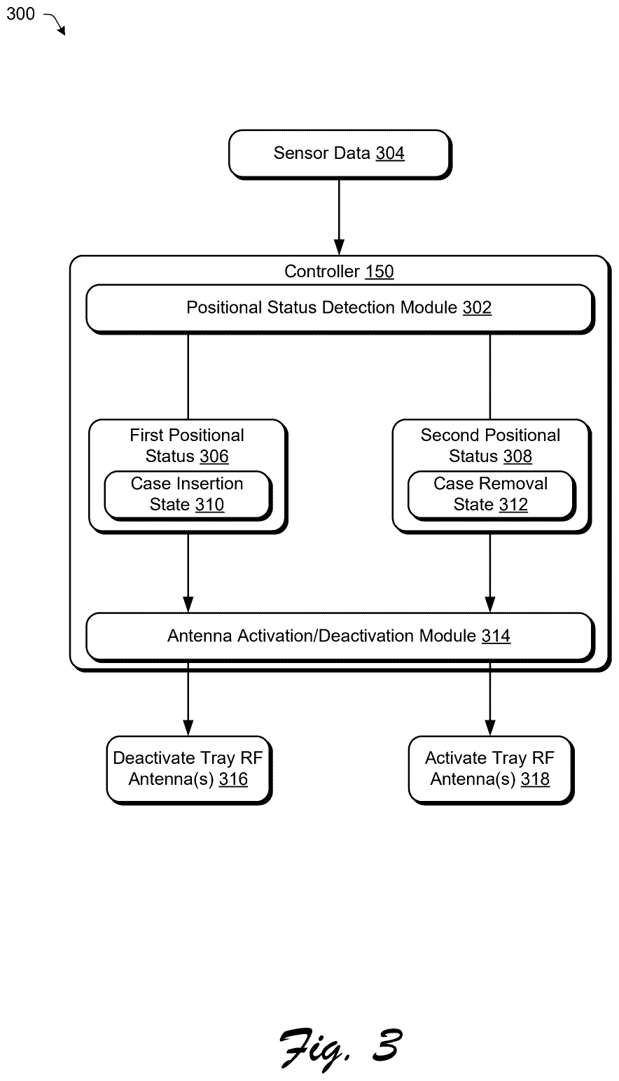

FIG. 3 illustrates an example system 300 for activating and deactivating one or more radio frequency antennas in accordance with the described techniques. Here, the controller 150 includes a positional status detection module 302, which is configured to detect a positional status of the wireless earbuds 104. To do so, the positional status detection module 302 receives sensor data 304 (e.g., from the insertion sensor of the sensors 140) indicating whether the wireless earbuds 104 are inserted in the cavities 114, 116 of the earbuds case 102. Based on the sensor data 304, the positional status detection module 302 detects whether the wireless earbuds 104 are in a first positional status 306 or a second positional status 308. For instance, the positional status detection module 302 detects the first positional status 306 when the wireless earbuds 104 are inserted in the cavities 114, 116 of the earbuds case 102, e.g., the case insertion state 310. Furthermore, the positional status detection module 302 detects the second positional status 308 when the wireless earbuds 104 are removed from the cavities 114, 116 of the earbuds case 102, e.g., the case removal state 312.

As shown, the detected positional status is provided as input to an antenna activation/deactivation module 314, which is configured to initiate an activation or a deactivation of the tray RF antenna(s) 128 based on the detected positional status. In particular, the antenna activation/deactivation module 314 initiates a deactivation of the tray RF antenna(s) 128 responsive to the first positional status 306 being detected, as shown at 316. To do so, the antenna activation/deactivation module 314 issues an antenna deactivation instruction to the antenna switching module 138, which in one or more implementations is configured as an electrical switch. In response to receiving the antenna deactivation instruction, the antenna switching module 138 disconnects the tray RF antenna(s) 128 from the RF front end 132, which breaks the electrical connection between the tray RF antenna(s) 128 and the RF front end 132 (e.g., the power supply of the tray RF antenna(s) 128), thereby deactivating the tray RF antenna(s) 128.

Similarly, the antenna activation/deactivation module 314 initiates an activation of the tray RF antenna(s) 128 responsive to the second positional status 308 being detected, as shown at 318. To do so, the antenna activation/deactivation module 314 issues an antenna activation instruction to the antenna switching module 138, e.g., configured as the electrical switch. In response to receiving the antenna deactivation instruction, the antenna switching module 138 connects the tray RF antenna(s) 128 to the RF front end 132, which completes the electrical connection between the tray RF antenna(s) 128 and the RF front end 132 (e.g., the power supply of the tray RF antenna(s) 128), thereby activating the tray RF antenna(s) 128.

Although the example system 300 of FIG. 3 is depicted and described as an electronic switching scheme in which a controller 150 implemented in electronic circuitry issues instructions controlling an electrical switch that powers the tray RF antenna(s) 128, this example is not to be construed as limiting. For example, the antenna switching module 138 is a mechanical switch which controls the activation and deactivation of the tray RF antenna(s) 128 based on the positional status of the wireless earbuds 104 in various implementations. In at least one non-limiting example, the mechanical switch is configured as a pogo pin, which is a spring-loaded, expandable, electrical connector. In this example, the pogo pin is permanently connected to a power supply. Furthermore, the pogo pin is configured to expand and contact the tray RF antenna(s) 128 responsive to the wireless earbuds 104 being removed from the cavities 114, 116. The contact completes a circuit with the power supply, thereby activating the tray RF antenna 128. Moreover, the pogo pin is configured to contract to release contact with the tray RF antenna(s) 128 responsive to the wireless earbuds 104 being inserted in the cavities 114, 116. The release of contact breaks the circuit with the power supply, thereby deactivating the tray RF antenna 128.

It should be noted that the base RF antennas 126 remain activated regardless of whether the wireless earbuds 104 are inserted in or removed from the cavities 114, 116. Thus, when the wireless earbuds 104 are removed from the cavities 114, 116, the tray RF antenna(s) 128 and the base RF antenna(s) 126 are configured to operate as a MIMO antenna system. When configured as low band antennas, for instance, the base RF antenna(s) 126 and the tray RF antenna(s) operate as a low band MIMO antenna system. When configured as MB/HB/UHB antennas, the base RF antenna(s) 126 and the tray RF antenna(s) operate as a MB/HB/UHB MIMO antenna system. When configured as Wi-Fi antennas, the base RF antenna(s) 126 and the tray RF antenna(s) operate as a Wi-Fi MIMO antenna system. Depending on the number of antennas within the antenna system 124, the base RF antenna(s) 126 and the tray RF antenna(s) 128 are configured to operate as a 2×2 MIMO system and/or a 4×4 MIMO system in various examples.

Furthermore, when the wireless earbuds 104 are inserted in the cavities 114, 116, the base RF antennas 126 remain activated. For example, one or more base RF antennas 126 configured as low band antennas remain operable as a SISO low band antenna or a reduced low band MIMO antenna system (e.g., a 2×2 MIMO system rather than a 4×4 MIMO antenna system), one or more base RF antennas 126 configured as MB/HB/UHB antennas remain operable as a SISO MB/HB/UHB antenna or a reduced MB/HB/UHB MIMO antenna system (e.g., a 2×2 MIMO system rather than a 4×4 MIMO antenna system), and/or one or more base RF antennas 126 configured as Wi-Fi antennas remain operable as a SISO Wi-Fi antenna or a reduced Wi-Fi MIMO antenna system, e.g., a 2×2 MIMO system rather than a 4×4 MIMO antenna system.

In variations, however, the controller 150 and/or the antenna switching module 138 are further configured to control the activation and deactivation of all antennas of the antenna system 124. By way of example, the antenna switching module 138 is configured to activate all antennas of the antenna system 124 responsive to the wireless earbuds 104 being removed from the cavities 114, 116. Moreover, the antenna switching module 138 is configured to deactivate the tray RF antenna(s) 128, and optionally, at least one additional antenna of the antenna system 124 responsive to the wireless earbuds 104 being inserted in the cavities 114, 116. In at least one specific but non-limiting example, the antenna switching module 138 is configured to deactivate all antennas of the antenna system, 124 responsive to the wireless earbuds 104 being inserted in the cavities 114, 116.

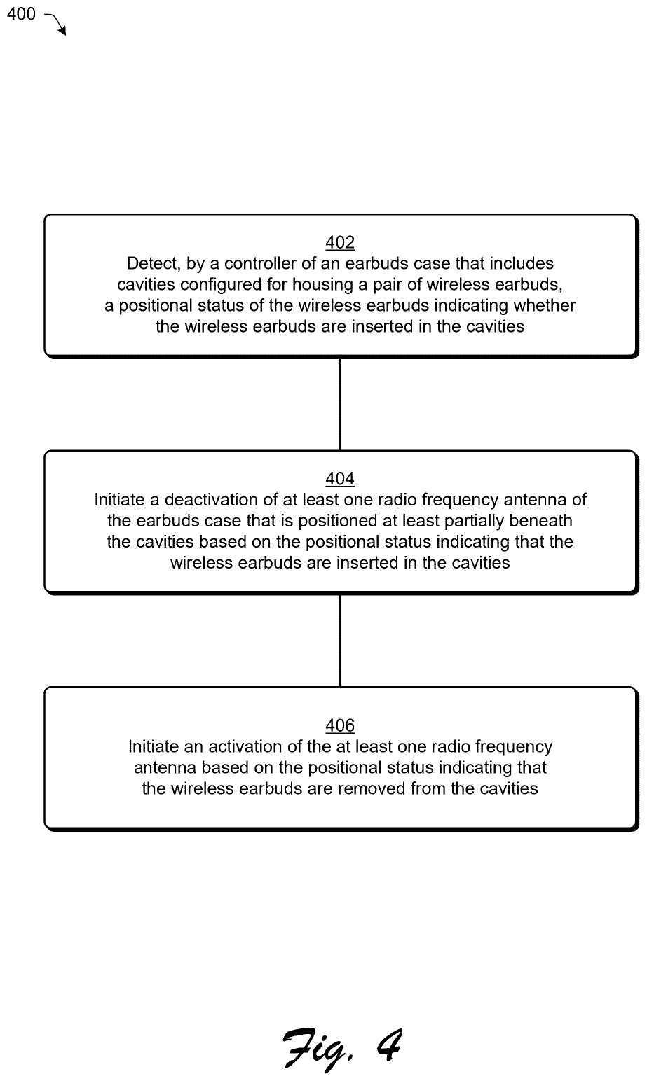

FIG. 4 illustrates a flow chart depicting an example method 400 of radio frequency antenna architecture for a wireless earbuds case can be implemented at least partially by an antenna switching module configured as an electrical switch. At 402, a controller of an earbuds case that includes cavities for housing a pair of wireless earbuds detects a positional status of the wireless earbuds indicating whether the wireless earbuds are inserted in the cavities. For example, the controller 150 of the earbuds case 102 receives sensor data 304, and based on the sensor data 304, detects a positional status of the wireless earbuds 104 indicating whether the wireless earbuds 104 are inserted in the cavities 114, 116 of the earbuds case 102.

At 404, a deactivation of at least one radio frequency antenna of the earbuds case that is positioned at least partially beneath the cavities is initiated based on the positional status indicating that the wireless earbuds are inserted in the cavities. For instance, the controller 150 issues a deactivation instruction to the antenna switching module 138 instructing the antenna switching module 138 to deactivate the tray RF antenna(s) 128 responsive to detecting the first positional status 306 in which the wireless earbuds 104 are inserted in the cavities 114, 116. Here, the antenna switching module 138 (e.g., configured as an electrical switch) disconnects the tray RF antenna(s) 128 from the RF front end 132, which deactivates the tray RF antenna(s) 128. As discussed herein, the tray RF antenna(s) 128 are positioned within the tray 108 and beneath the cavities 114, 116.

At 406, an activation of the at least one radio frequency antenna is initiated based on the positional status indicating that the wireless earbuds are removed from the cavities. For example, the controller 150 issues an activation instruction to the antenna switching module 138 instructing the antenna switching module 138 to activate the tray RF antenna(s) 128 responsive to detecting the second positional status 308 in which the wireless earbuds 104 are removed from the cavities 114, 116. Here, the antenna switching module 138 (e.g., configured as an electrical switch) connects the tray RF antenna(s) 128 to the RF front end 132, which activates the tray RF antenna(s) 128.

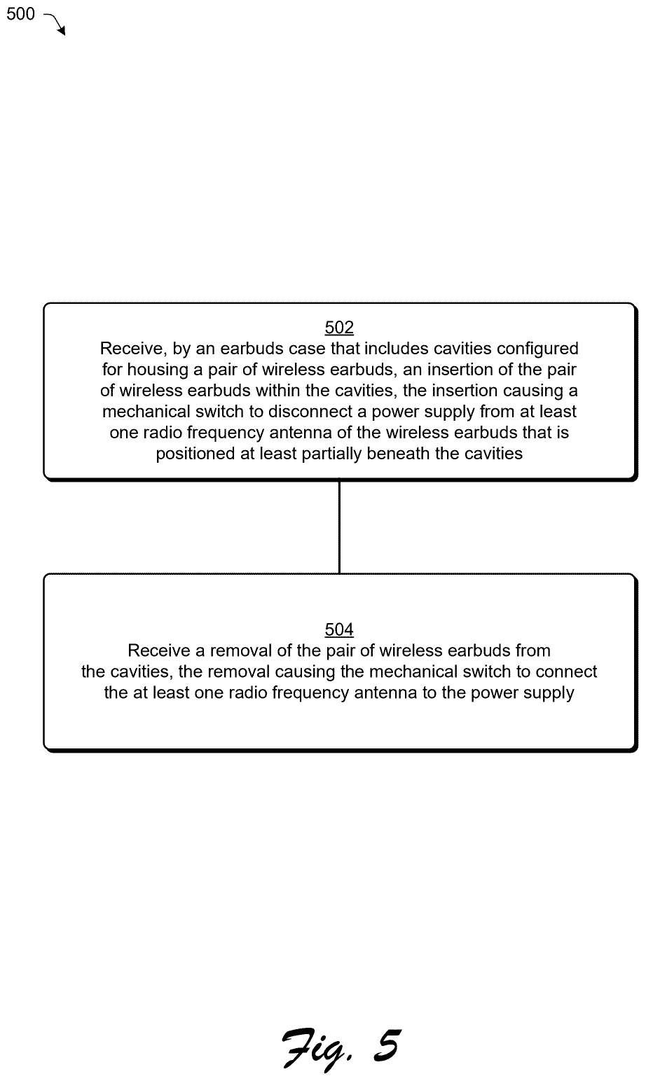

FIG. 5 illustrates a flow chart depicting an example method 500 for radio frequency antenna architecture for a wireless earbuds case as implemented at least partially by an antenna switching module configured as a mechanical switch. At 502, an earbuds case that includes cavities configured for housing a pair of wireless earbuds receives an insertion of the pair of wireless earbuds within the cavities, and the insertion causes a mechanical switch to disconnect a power supply from at least one radio frequency antenna of the earbuds case that is positioned at least partially beneath the cavities. For example, the wireless earbuds 104 are inserted into the cavities 114, 116 of the earbuds case 102. Here, the antenna switching module 138 is configured as a mechanical switch (e.g., a pogo pin) that is connected to a power supply. The insertion of the wireless earbuds 104 in the cavities 114, 116 causes the mechanical switch to contract and break contact with the tray RF antenna(s) 128, thereby disconnecting the tray RF antenna(s) 128 from power and deactivating the tray RF antenna(s) 128. As discussed herein, the tray RF antenna(s) 128 are positioned within the tray 108 and beneath the cavities 114, 116.

At 504, a removal of the pair of earbuds from the cavities is received, and the removal causes the mechanical switch to connect the at least one radio frequency antenna to the power supply. By way of example, the wireless earbuds 104 are removed from the cavities 114, 116 of the earbuds case 102. This removal causes the mechanical switch to expand and contact the tray RF antenna(s) 128, thereby connecting the tray RF antenna 128 to power and activating the tray RF antenna(s) 128.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

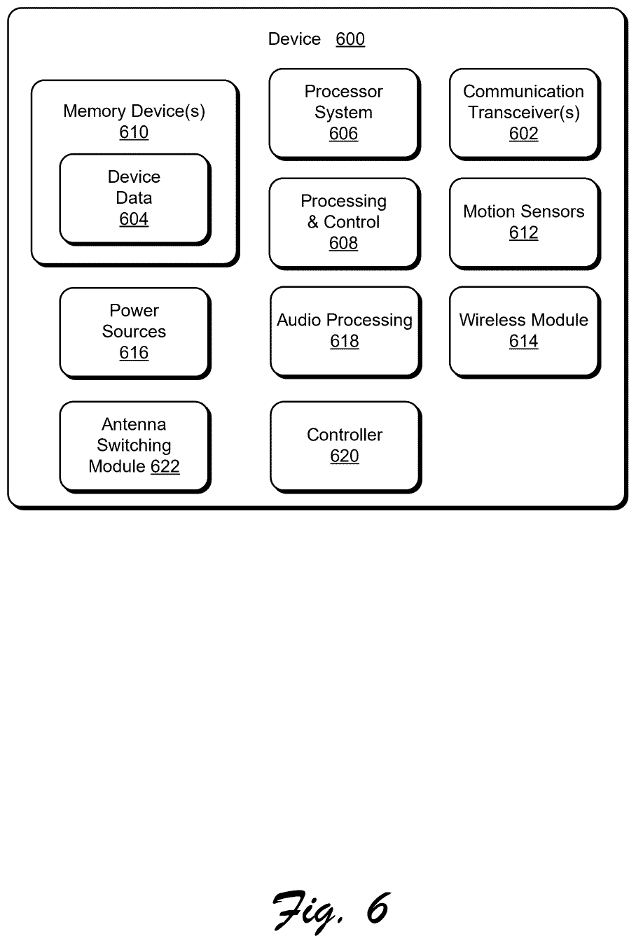

FIG. 6 illustrates various components of an example device 600 in which aspects of the described techniques can be implemented. For example, the earbuds case 102 as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include audio data. Example communication transceivers 602 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 includes a processing system 606 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory 610 (e.g., memory devices) that enable data storage, such as data storage devices that can be accessed by a computing device, and that provide persistent storage of data and executable instructions (e.g., software applications, programs, functions, and the like). Examples of the computer-readable storage memory 610 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device. The computer-readable storage memory 610 provides data storage mechanisms to store the device data 604, and/or other types of information and/or data.

The example device 600 can also include motion sensors 612. The motion sensors 612, for instance, may include motion sensors such as may be implemented in an inertial measurement unit (IMU). The motion sensors 612 can be implemented with various sensors, such as a gyroscope, an accelerometer, and/or other types of motion sensors to sense motion of the device.

The device 600 also includes a wireless module 614, which is representative of functionality to perform various wireless communication tasks. The device 600 can also include one or more power sources 616. The power sources 616 may include a charging and/or power system, and can be implemented as a flexible strip battery, a rechargeable battery, a charged super-capacitor, and/or any other type of active or passive power source.

The device 600 also includes an audio processing system 618 that generates audio data, e.g., for output by the wireless earbuds 104. The audio processing system 618 may include any devices that process and render audio. Audio signals can be communicated to an audio component (e.g., the wireless earbuds 104) via an RF (radio frequency) link, or other similar communication link.

In this example, the device 600 includes a controller 620 and an antenna switching module 622 that implement aspects of radio frequency antenna architecture for a wireless earbuds case. For example, the controller 620 can be implemented as the controller 150 described in detail above, while the antenna switching module 622 can be implemented as the antenna switching module 138 described in detail above. In implementations, the controller 620 and/or the antenna switching module 622 may include independent processing, memory, and logic components as a computing and/or electronic device integrated with the device 600.

Although implementations of radio frequency antenna architecture for a wireless earbuds case have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a device configured as an earbuds case, the device comprising cavities configured for housing a pair of wireless earbuds and at least one radio frequency antenna positioned at least partially beneath the cavities, wherein an activation of the at least one radio frequency antenna is controlled based on whether the wireless earbuds are inserted in the cavities.

In some aspects, the techniques described herein relate to a device, wherein the earbuds case includes a first housing configured as a base and a second housing configured as a tray that includes the cavities, and the base and the tray are physically attached to one another to enclose one or more circuitry components of the earbuds case.

In some aspects, the techniques described herein relate to a device, wherein the at least one radio frequency antenna is positioned within the tray, and the base includes at least one additional radio frequency antenna operating in a same frequency band as the at least one radio frequency antenna.

In some aspects, the techniques described herein relate to a device, wherein the at least one radio frequency antenna includes a radio frequency antenna having a first arm and a second arm.

In some aspects, the techniques described herein relate to a device, wherein the first arm is positioned at least partially beneath a first cavity of the cavities configured for housing a first wireless earbud of the pair of wireless earbuds, and the second arm is positioned at least partially beneath a second cavity of the cavities configured for housing a second wireless earbud of the pair of wireless earbuds.

In some aspects, the techniques described herein relate to a device, wherein the first arm conforms to a first shape of the first cavity, and the second arm conforms to a second shape of the second cavity.

In some aspects, the techniques described herein relate to a device, wherein the cavities each include one or more sub-cavities for housing differently shaped physical components of the wireless earbuds, at least a portion of the first arm runs wraps at least partially around a sub-cavity of the first cavity, and at least a portion of the second arm wraps at least partially around an additional sub-cavity of the second cavity.

In some aspects, the techniques described herein relate to a device, wherein the at least one radio frequency antenna is configured to be activated while the wireless earbuds are removed from the cavities of the earbuds case.

In some aspects, the techniques described herein relate to a device, wherein the earbuds case includes at least one additional radio frequency antenna, wherein the at least one radio frequency antenna and the at least one additional radio frequency antenna are activated and operating as a multiple input multiple output (MIMO) antenna system while the wireless earbuds are removed from the cavities.

In some aspects, the techniques described herein relate to a device, wherein the at least one radio frequency antenna is configured to be deactivated while the wireless earbuds are inserted in the cavities of the earbuds case.

In some aspects, the techniques described herein relate to a device, wherein the earbuds case further includes at least one additional radio frequency antenna configured to remain activated while the wireless earbuds are inserted in the cavities of the earbuds case.

In some aspects, the techniques described herein relate to a device, further comprising a mechanical switch configured to expand responsive to the wireless earbuds being removed from the cavities of the earbuds case to establish an electrical connection to the at least one radio frequency antenna, and contract responsive to the wireless earbuds being inserted into the cavities of the earbuds case to disconnect the electrical connection from the at least one radio frequency antenna.

In some aspects, the techniques described herein relate to a device, further comprising a controller configured to receive sensor data indicating a positional status of the wireless earbuds indicating whether the wireless earbuds are inserted in the cavities of the earbuds case, and control an activation of the at least one radio frequency antenna based on the positional status.

In some aspects, the techniques described herein relate to a configured as an earbuds case, the device comprising cavities configured for housing a pair of wireless earbuds. at least one radio frequency antenna positioned at least partially beneath the cavities, and a controller to initiate an activation of the at least one radio frequency antenna responsive to detecting the wireless earbuds having been removed from the cavities.

In some aspects, the techniques described herein relate to a device, wherein the device includes at least one additional radio frequency antenna, wherein the at least one radio frequency antenna and the at least one additional radio frequency antenna are activated and operating as a multiple input multiple output (MIMO) antenna system while the wireless earbuds are removed from the cavities.

In some aspects, the techniques described herein relate to a device, wherein the earbuds case includes a first housing configured as a base and a second housing configured as a tray that includes the cavities, the base and the tray are physically coupled to one another to enclose one or more circuitry components of the earbuds case, the at least one radio frequency antenna is positioned within the tray, and at least one additional low band antenna is positioned within the base.

In some aspects, the techniques described herein relate to a device, wherein the at least one radio frequency antenna includes a radio frequency antenna having a first arm and a second arm.

In some aspects, the techniques described herein relate to a device, wherein the first arm is positioned at least partially beneath a first cavity of the cavities configured for housing a first wireless earbud of the pair of wireless earbuds, and the second arm is positioned at least partially beneath a second cavity of the cavities configured for housing a second wireless earbud of the pair of wireless earbuds.

In some aspects, the techniques described herein relate to a device, wherein the first arm conforms to a first shape of the first cavity, and the second arm conforms to a second shape of the second cavity.

In some aspects, the techniques described herein relate to a method comprising detecting, by a controller of an earbuds case that includes cavities configured for housing a pair of wireless earbuds, a positional status of the wireless earbuds indicating that the wireless earbuds are inserted in the cavities, and initiating, by the controller, a deactivation of at least one radio frequency antenna of the earbuds case that is positioned at least partially beneath the cavities based on the positional status.

What is claimed is:

1. A device configured as an earbuds case, the device comprising cavities configured for housing a pair of wireless earbuds and at least one radio frequency antenna positioned at least partially beneath the cavities, wherein an activation of the at least one radio frequency antenna is controlled based on whether the wireless earbuds are inserted in the cavities.

2. The device of claim 1, wherein the earbuds case includes a first housing configured as a base and a second housing configured as a tray that includes the cavities, and the base and the tray are physically attached to one another to enclose one or more circuitry components of the earbuds case.

3. The device of claim 2, wherein the at least one radio frequency antenna is positioned within the tray, and the base includes at least one additional radio frequency antenna operating in a same frequency band as the at least one radio frequency antenna.

4. The device of claim 1, wherein the at least one radio frequency antenna includes a radio frequency antenna having a first arm and a second arm.

5. The device of claim 4, wherein the first arm is positioned at least partially beneath a first cavity of the cavities configured for housing a first wireless earbud of the pair of wireless earbuds, and the second arm is positioned at least partially beneath a second cavity of the cavities configured for housing a second wireless earbud of the pair of wireless earbuds.

6. The device of claim 5, wherein the first arm conforms to a first shape of the first cavity, and the second arm conforms to a second shape of the second cavity.

7. The device of claim 5, wherein the cavities each include one or more sub-cavities for housing differently shaped physical components of the wireless earbuds, at least a portion of the first arm runs wraps at least partially around a sub-cavity of the first cavity, and at least a portion of the second arm wraps at least partially around an additional sub-cavity of the second cavity.

8. The device of claim 1, wherein the at least one radio frequency antenna is configured to be activated while the wireless earbuds are removed from the cavities of the earbuds case.

9. The device of claim 8, wherein the earbuds case includes at least one additional radio frequency antenna, wherein the at least one radio frequency antenna and the at least one additional radio frequency antenna are activated and operating as a multiple input multiple output (MIMO) antenna system while the wireless earbuds are removed from the cavities.

10. The device of claim 1, wherein the at least one radio frequency antenna is configured to be deactivated while the wireless earbuds are inserted in the cavities of the earbuds case.

11. The device of claim 10, wherein the earbuds case further includes at least one additional radio frequency antenna configured to remain activated while the wireless earbuds are inserted in the cavities of the earbuds case.

12. The device of claim 1, further comprising a mechanical switch configured to:
expand responsive to the wireless earbuds being removed from the cavities of the earbuds case to establish an electrical connection to the at least one radio frequency antenna; and
contract responsive to the wireless earbuds being inserted into the cavities of the earbuds case to disconnect the electrical connection from the at least one radio frequency antenna.

13. The device of claim 1, further comprising a controller configured to:
receive sensor data indicating a positional status of the wireless earbuds indicating whether the wireless earbuds are inserted in the cavities of the earbuds case; and
control an activation of the at least one radio frequency antenna based on the positional status.

14. A device configured as an earbuds case, the device comprising:
cavities configured for housing a pair of wireless earbuds;
at least one radio frequency antenna positioned at least partially beneath the cavities; and
a controller to initiate an activation of the at least one radio frequency antenna responsive to detecting the wireless earbuds having been removed from the cavities.

15. The device of claim 14, wherein the device includes at least one additional radio frequency antenna, wherein the at least one radio frequency antenna and the at least one additional radio frequency antenna are activated and operating as a multiple input multiple output (MIMO) antenna system while the wireless earbuds are removed from the cavities.

16. The device of claim 15, wherein the earbuds case includes a first housing configured as a base and a second housing configured as a tray that includes the cavities, the base and the tray are physically coupled to one another to enclose one or more circuitry components of the earbuds case, the at least one radio frequency antenna is positioned within the tray, and at least one additional low band antenna is positioned within the base.

17. The device of claim 15, wherein the at least one radio frequency antenna includes a radio frequency antenna having a first arm and a second arm.

18. The device of claim 17, wherein the first arm is positioned at least partially beneath a first cavity of the cavities configured for housing a first wireless earbud of the pair of wireless earbuds, and the second arm is positioned at least partially beneath a second cavity of the cavities configured for housing a second wireless earbud of the pair of wireless earbuds.

19. The device of claim 18, wherein the first arm conforms to a first shape of the first cavity, and the second arm conforms to a second shape of the second cavity.

20. A method comprising:
detecting, by a controller of an earbuds case that includes cavities configured for housing a pair of wireless earbuds, a positional status of the wireless earbuds indicating that the wireless earbuds are inserted in the cavities; and
initiating, by the controller, a deactivation of at least one radio frequency antenna of the earbuds case that is positioned at least partially beneath the cavities based on the positional status.
